(19) United States
(12) Patent Application Publication
(10) Pub. No.: US 2026/0020124 A1
(43) Pub. Date: Jan. 15, 2026

(54) ADJUSTMENT METHOD FOR LIGHT EMITTING SYSTEM AND LIGHT EMITTING SYSTEM

(71) Applicant: STAR ASIA VISION CORPORATION, Hsinchu City (TW)

(72) Inventors: Ching-Tien Lien, Hsinchu City (TW); Kuo-Shu HUANG, Hsinchu City (TW); Kai-Wen Chen, Hsinchu City (TW)

(21) Appl. No.: 18/938,801

(22) Filed: Nov. 6, 2024

(30) Foreign Application Priority Data
Jul. 15, 2024 (TW) 113126366

(51) Int. Cl. H05B 45/28

(52) U.S. Cl. CPC H05B 45/28

(57) ABSTRACT

An adjustment method for a light emitting system and a light emitting system are provided. The light emitting system comprises a plurality of light emitting elements and a control circuit. Each of the light emitting elements has a corresponding lighting setting value. The adjustment method comprises: establishing correlation values between a target color temperature, which ranges from 1000K to 12000K, and the lighting setting values; summing the correlation values to generate a total and calculating a percentage of each of the correlation values relative to the total; and setting emission power of each of the light emitting elements according to the corresponding percentage of each of the light emitting elements. The mixed light that matches the target color temperature is then provided, and the color rendering index (CRI) of the mixed light has Ra>90.

### CROSS-REFERENCES TO RELATED APPLICATIONS

This application claims the benefit of priority to Taiwanese Patent Application No. 113126366 filed on Jul. 15, 2024, which is hereby incorporated by reference in its entirety.

### BACKGROUND OF THE INVENTION

### Field of the Invention

The present invention relates to an adjustment method for a light emitting system and the light emitting system thereof, and in particular to an adjustment method for adjusting the light provided by a light emitting system to a target color temperature.

### Descriptions of the Related Art

As lighting technology continues to mature, manufacturers are becoming increasingly stringent about the parameters of light to better meet the specific requirements of various applications. Among these parameters, color temperature is a critical factor for adjusting lighting to suit different scenarios. Natural light at dusk and candlelight are categorized as low color temperature lighting, which can produce a relaxing effect and promote the normal secretion of melatonin, aiding sleep. As a result, such lighting is widely used in parks, cafes, and bedrooms. Soft, medium color temperature lighting creates a sense of calm and comfort and can be used for extended periods without causing eye strain. Therefore, it is often used in spaces like study rooms, offices, hospitals, art galleries, and hotels. On the other hand, bright, high color temperature lighting can help maintain concentration and energy levels, making it common in places requiring high attention, such as classrooms, conference rooms, or gyms.

Although fixed color temperature lighting systems can be selected based on the intended use of the space, it is also common for the lighting needs within the same space to change depending on the time or the user. For example, the color temperature requirements for waking up and falling asleep at home differ from those for reading, working, or dining at home. To allow a single lighting system to provide more versatile applications, the industry has gradually developed single lighting systems capable of offering more than one color temperature to meet the varying needs of consumers at different times, while also reducing the space consumption of multiple lighting systems installed in the same area.

Currently, there are several light emitting systems on the market that can switch between different color temperatures, such as a system that switches between low and high color temperatures at 3000K and 5000K. However, such traditional systems can only switch between these two color temperatures, offering a limited range of adjustable color temperatures. If one tries to expand the adjustable color temperature range, the chromaticity deviation value (Duv) of the lighting would exceed the 7-step MacAdam Ellipses (7-step MAE). Another conventional system uses blue light emitting diodes (LEDs), red light emitting diodes, and white light emitting diodes for adjustment. However, this system cannot simultaneously achieve the desired color rendering when providing mixed light at high color temperatures.

In view of the above, there is an urgent need in the industry for an adjustment method applicable to a single light emitting system that allows for adjustments across a wide color temperature range while maintaining good color rendering in the emitted light, thus avoiding color distortion.

### SUMMARY OF THE INVENTION

The main objective of the present invention is to provide an adjustment method for a light emitting system that can provide mixed light that matches a desired target color temperature, selected within a wide range of color temperatures, and simultaneously achieve excellent lighting effects with high color rendering, low chromaticity deviation, and low color tolerance.

To achieve the above objectives, the present invention discloses an adjustment method for a light emitting system, which includes a plurality of light emitting elements. The adjustment method comprises: setting a target color temperature, where the target color temperature ranges between 1000K and 12000K; establishing a correlation value between the target color temperature and a lighting setting value of each of the light emitting elements; calculating a total of the correlation values; individually calculating a correlation percentage of each of the correlation values relative to the total; and setting emission power of each of the light emitting elements according to the corresponding correlation percentage to collectively provide a mixed light.

In one embodiment, each of the lighting setting values includes at least one of a color coordinate and a wavelength range setting value.

In one embodiment, the light emitting elements are selected from the group consisting of a first light emitting element, a second light emitting element, a third light emitting element, a fourth light emitting element, and combinations thereof. The lighting setting value of the first light emitting element includes a first color coordinate, and the first color coordinate is a chromaticity x value of 0.16-0.22 and a chromaticity y value of 0.23-0.3 on the 1931 CIE chromaticity diagram. The lighting setting value of the second light emitting element includes a second color coordinate, and the lighting setting value of the second light emitting element is a chromaticity x value of 0.37-0.47 and a chromaticity y value of 0.36-0.43 on the 1931 CIE chromaticity diagram. The lighting setting value of the third light emitting element includes a third color coordinate, and the third color coordinate is a chromaticity x value of 0.53-0.6 and a chromaticity y value of 0.4-0.45 on the 1931 CIE chromaticity diagram. The lighting setting value of the fourth light emitting element includes a fourth color coordinate, and the fourth color coordinate is a chromaticity x value of 0.645-0.68 and a chromaticity y value of 0.32-0.335 on the 1931 CIE chromaticity diagram.

In one embodiment, on the 1931 CIE chromaticity diagram, the first color coordinate, the second color coordinate, the third color coordinate, and the fourth color coordinate are connected by a plurality of line segments to form a quadrilateral. The mixed light has a mixed light color coordinate on the 1931 CIE chromaticity diagram, and the mixed light color coordinate is located within the quadrilateral.

In one embodiment, the lighting setting value of the first light emitting element includes a first wavelength range setting value. When the first wavelength range setting value is between 450 nm and 460 nm, emission intensity of the first light emitting element is more than or equal to 80% of maximum emission intensity of the first light emitting element. The lighting setting value of the second light emitting element includes a second wavelength range setting value. When the second wavelength range setting value is between 620 nm and 640 nm, emission intensity of the second light emitting element is at maximum emission intensity of the second light emitting element. The lighting setting value of the third light emitting element includes a third wavelength range setting value. When the third wavelength range setting value is between 590 nm and 630 nm, emission intensity of the third light emitting element is more than or equal to 80% of maximum emission intensity of the third light emitting element. The lighting setting value of the fourth light emitting element includes a fourth wavelength range setting value. When the fourth wavelength range setting value is between 620 nm and 650 nm, emission intensity of the fourth light emitting element is more than or equal to 80% of maximum emission intensity of the fourth light emitting element.

In one embodiment, when the first wavelength range setting value is between 460 nm and 470 nm, the emission intensity of the first light emitting element is between 60% and 80% of the maximum emission intensity of the first light emitting element, when the first wavelength range setting value is between 490 nm and 530 nm, the emission intensity of the first light emitting element is between 40% and 60% of the maximum emission intensity of the first light emitting element, when the first wavelength range setting value is between 540 nm and 560 nm, the emission intensity of the first light emitting element is between 20% and 40% of the maximum emission intensity of the first light emitting element, when the first wavelength range setting value is more than or equal to 580 nm, the emission intensity of the first light emitting element is less than or equal to 20% of the maximum emission intensity of the first light emitting element. When the second wavelength range setting value is between 400 nm and 500 nm, the emission intensity of the second light emitting element is less than or equal to 30% of the maximum emission intensity of the second light emitting element, when the second wavelength range setting value is between 500 nm and 600 nm, the emission intensity of the second light emitting element is between 5% and 30% of the maximum emission intensity of the second light emitting element, when the second wavelength range setting value is between 600 nm and 620 nm, the emission intensity of the second light emitting element is between 40% and the maximum emission intensity of the second light emitting element, when the second wavelength range setting value is between 640 nm and 650 nm, the emission intensity of the second light emitting element is between 20% and 30% of the maximum emission intensity of the second light emitting element. When the third wavelength range setting value is between 410 nm and 470 nm, the emission intensity of the third light emitting element is between 1% and 5% of the maximum emission intensity of the third light emitting element. When the fourth wavelength range setting value is below 580 nm, the emission intensity of the fourth light emitting element is less than or equal to 20% of the maximum emission intensity of the fourth light emitting element, when the fourth wavelength range setting value is between 590 nm and 600 nm, the emission intensity of the fourth light emitting element is between 20% and 60% of the maximum emission intensity of the fourth light emitting element, when the fourth wavelength range setting value is between 600 nm and 610 nm, the emission intensity of the fourth light emitting element is between 40% and 80% of the maximum emission intensity of the fourth light emitting element, when the fourth wavelength range setting value is between 660 nm and 670 nm, the emission intensity of the fourth light emitting element is between 40% and 80% of the maximum emission intensity of the fourth light emitting element, when the fourth wavelength range setting value is between 680 nm and 700 nm, the emission intensity of the fourth light emitting element is between 20% and 40% of the maximum emission intensity of the fourth light emitting element, when the fourth wavelength range setting value is between 710 nm and 810 nm, the emission intensity of the fourth light emitting element is less than or equal to 20% of the maximum emission intensity of the fourth light emitting element.

In one embodiment, a chromaticity deviation value (Duv) of the mixed light is that the mixed light color coordinate is located within a target 7-step MacAdam Ellipse corresponding to the target color temperature.

In one embodiment, in the step of establishing a correlation value between the target color temperature and a lighting setting value of each of the light emitting elements, the target color temperature is plotted on the 1931 CIE chromaticity diagram, and lines are drawn connecting the target color temperature on the 1931 CIE chromaticity diagram with the first color coordinate, the second color coordinate, the third color coordinate, and the fourth color coordinate, resulting a first line segment, a second line segment, a third line segment, and a fourth line segment. Each of the correlation values of each of the light emitting elements is positively correlated with a length of the corresponding line segments.

In one embodiment, each of the correlation percentages is positively correlated with the corresponding emission power.

In one embodiment, the color rendering index (CRI) of the mixed light has Ra>90 and R9>50.

In one embodiment, when the emission power of the third light emitting element and the emission power of the fourth light emitting element are both set to 0, the target color temperature ranges between 3000K and 6500K.

In one embodiment, when the emission power of the first light emitting element and the emission power of the fourth light emitting element are both set to 0, the target color temperature ranges between 2200K and 3000K.

To achieve the above objective, the present invention further discloses a light emitting system comprising a first light emitting element, a second light emitting element, a third light emitting element, a fourth light emitting element, and a control circuit. The first light emitting element provides a first colored light, which is represented by a first color coordinate on the 1931 CIE chromaticity diagram with a chromaticity x value of 0.16-0.22 and a chromaticity y value of 0.23-0.30. When a wavelength of the first colored light is between 450 nm and 460 nm, emission intensity of the first light emitting element is more than or equal to 80% of maximum emission intensity of the first light emitting element. The second light emitting element provides a second colored light, which is represented by a second color coordinate on the 1931 CIE chromaticity diagram with a chromaticity x value of 0.37-0.47 and a chromaticity y value of 0.36-0.43. When a wavelength of the second colored light is between 620 nm and 640 nm, emission intensity of the second light emitting element is at maximum emission intensity of the second light emitting element. The third light emitting element provides a third colored light, which is represented by a third color coordinate on the 1931 CIE chromaticity diagram with a chromaticity x value of 0.53-0.6 and a chromaticity y value of 0.4-0.45. When a wavelength of the third colored light is between 590 nm and 630 nm, emission intensity of the third light emitting element is more than or equal to 80% of maximum emission intensity of the third light emitting element. The fourth light emitting element provides a fourth colored light, which is represented by a fourth color coordinate on the 1931 CIE chromaticity diagram with a chromaticity x value of 0.645-0.68 and a chromaticity y value of 0.32-0.335. When a wavelength of the fourth colored light is between 620 nm and 650 nm, emission intensity of the fourth light emitting element is more than or equal to 80% of maximum emission intensity of the fourth light emitting element. The control circuit, based on a target color temperature and the chromaticity x and y values, provides a first emission power ratio signal to the first light emitting element to provide the first colored light, provides a second emission power ratio signal to the second light emitting element to provide the second colored light, provides a third emission power ratio signal to the third light emitting element to provide the third colored light, and provides a fourth emission power ratio signal to the fourth light emitting element to provide the fourth colored light. The target color temperature ranges between 1000K and 12000K.

After referring to the drawings and the embodiments as described in the following, those the ordinary skilled in this art can understand other objectives of the present invention, as well as the technical means and embodiments of the present invention.

### BRIEF DESCRIPTION OF THE DRAWINGS

FIG. 1 is a schematic diagram of a light emitting system according to an embodiment of the present invention;

FIG. 2 is a schematic diagram showing the correlation between the target color temperature and the lighting setting value of each of the light emitting elements in a light emitting system according to an embodiment of the present invention, when the target color temperature is 10000K, on a 1931 CIE chromaticity diagram that includes the blackbody locus;

FIG. 3 is a schematic diagram illustrating the adjustable target color temperature range of a light emitting system according to an embodiment of the present invention, on a 1931 CIE chromaticity diagram that includes the blackbody locus;

FIG. 4A is a schematic diagram showing the emission intensity corresponding to different wavelengths of the first colored light provided by the first light emitting element of a light emitting system according to an embodiment of the present invention;

FIG. 4B is a schematic diagram showing the emission intensity corresponding to different wavelengths of the second colored light provided by the second light emitting element of a light emitting system according to an embodiment of the present invention;

FIG. 4C is a schematic diagram showing the emission intensity corresponding to different wavelengths of the third colored light provided by the third light emitting element of a light emitting system according to an embodiment of the present invention;

FIG. 4D is a schematic diagram showing the emission intensity corresponding to different wavelengths of the fourth colored light provided by the fourth light emitting element of a light emitting system according to an embodiment of the present invention;

FIG. 5A is a schematic diagram illustrating the color temperature range of 2200K to 3000K of a light emitting system according to an embodiment of the present invention, on a 1931 CIE chromaticity diagram that includes the blackbody locus;

FIG. 5B is a schematic diagram illustrating the color temperature range of 3000K to 6500K of a light emitting system according to an embodiment of the present invention, on a 1931 CIE chromaticity diagram that includes the blackbody locus; and

FIG. 6 is a schematic diagram showing the chromaticity deviation value (Duv) and color tolerance on a 1931 CIE chromaticity diagram of a light emitting system according to an embodiment of the present invention, at different target color temperatures.

### DETAILED DESCRIPTION OF THE PREFERRED EMBODIMENT

In the following description, the present invention will be explained with reference to various embodiments thereof. These embodiments of the present invention are not intended to limit the present invention to any specific environment, application or particular method for implementations described in these embodiments. Therefore, the description of these embodiments is for illustrative purposes only and is not intended to limit the present invention. It shall be appreciated that, in the following embodiments and the attached drawings, a part of elements not directly related to the present invention may be omitted from the illustration, and dimensional proportions among individual elements and the numbers of each element in the accompanying drawings are provided only for ease of understanding but not to limit the present invention.

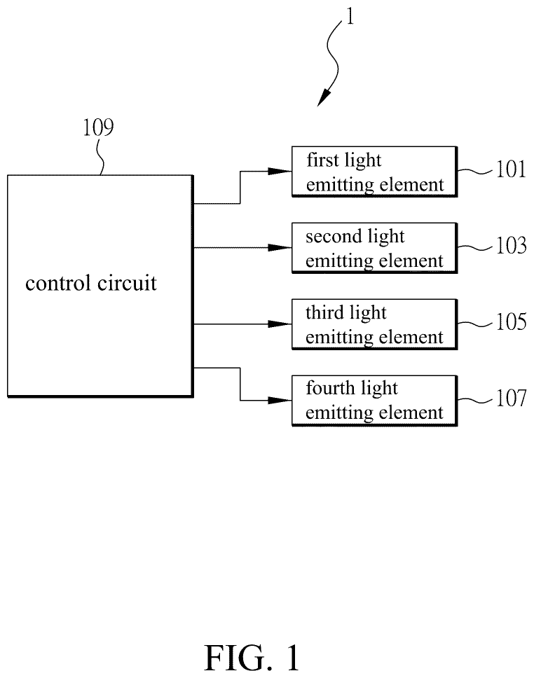

FIG. 1 to FIG. 6 illustrate an embodiment of the present invention. FIG. 1 depicts a light emitting system 1 of this embodiment, which includes a first light emitting element 101, a second light emitting element 103, a third light emitting element 105, a fourth light emitting element 107, and a control circuit 109.

The first light emitting element 101 is used to provide a first colored light. The first colored light has a first lighting setting value, which includes the chromaticity x and y values of the first colored light as indicated by a first color coordinate on the 1931 CIE chromaticity diagram. In this embodiment, the chromaticity x value range of the first color coordinate for the first colored light is 0.16-0.22, and the chromaticity y value range is 0.23-0.3.

The second light emitting element 103 is used to provide a second colored light. The second colored light has a second lighting setting value, which includes the chromaticity x and y values of the second colored light as indicated by a second color coordinate on the 1931 CIE chromaticity diagram. In this embodiment, the chromaticity x value range of the second color coordinate for the second colored light is 0.37-0.47, and the chromaticity y value range is 0.36-0.43.

The third light emitting element 105 is used to provide a third colored light. The third colored light has a third lighting setting value, which includes the chromaticity x and y values of the third colored light as indicated by a third color coordinate on the 1931 CIE chromaticity diagram. In this embodiment, the chromaticity x value range of the third color coordinate for the third colored light is 0.53-0.6, and the chromaticity y value range is 0.4-0.45.

The fourth light emitting element 107 is used to provide a fourth colored light. The fourth colored light has a fourth lighting setting value, which includes the chromaticity x and y values of the fourth colored light as indicated by a fourth color coordinate on the 1931 CIE chromaticity diagram. In this embodiment, the chromaticity x value range of the fourth color coordinate for the fourth colored light is 0.645-0.68, and the chromaticity y value range is 0.32-0.335.

When adjusting the light emitting system 1, a target color temperature is first set, which can range between 1000K and 12000K. The control circuit 109 establishes corresponding correlation values for the first light emitting element 101, the second light emitting element 103, the third light emitting element 105, and the fourth light emitting element 107 based on the target color temperature and the lighting setting values of these elements. By summing these correlation values, a total is obtained, and then a correlation percentage of each light emitting element's correlation value relative to the total is calculated individually. Subsequently, the control circuit 109 provides a first emission power ratio signal to the first light emitting element 101 to make it provide the first colored light. The control circuit 109 provides a second emission power ratio signal to the second light emitting element 103 to make it provide the second colored light. The control circuit 109 provides a third emission power ratio signal to the third light emitting element 105 to make it provide the third colored light. The control circuit 109 provides a fourth emission power ratio signal to the fourth light emitting element 107 to make it provide the fourth colored light. The first colored light, the second colored light, the third colored light, and the fourth colored light provided by the light emitting elements are combined to obtain mixed light, which has a color rendering index (CRI) of Ra>90 and R9>50.

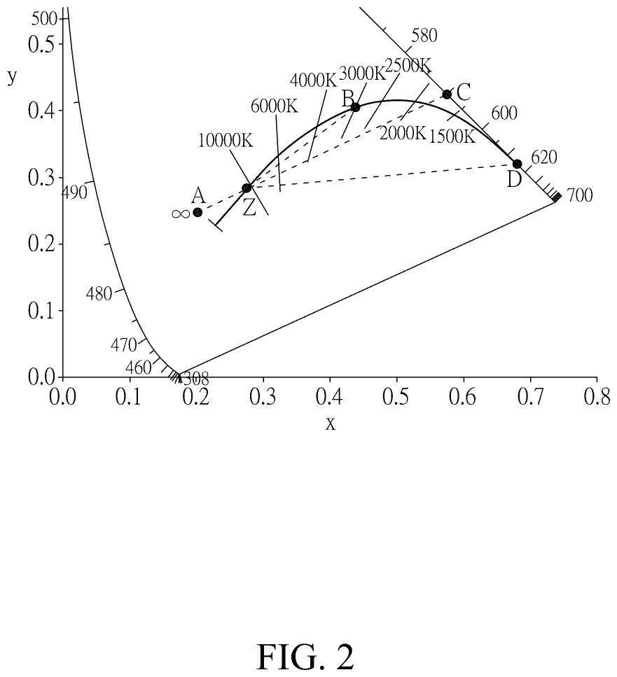

FIG. 2 illustrates, the light emitting system 1 in an embodiment of the present invention, the correlation between the target color temperature and the lighting setting value of each of the light emitting elements when the target color temperature is 10000K, as shown on the 1931 CIE chromaticity diagram including the blackbody locus. Specifically, when the target color temperature is 10000K, the target color temperature color coordinate Z is marked on the chromaticity diagram. The first colored light provided by the first light emitting element 101 is marked on the chromaticity diagram as the first color coordinate A, the second colored light provided by the second light emitting element 103 is marked as the second color coordinate B, the third colored light provided by the third light emitting element 105 is marked as the third color coordinate C, and the fourth colored light provided by the fourth light emitting element 107 is marked as the fourth color coordinate D.

Using the aforementioned adjustment method, connecting the target color temperature color coordinate Z with a first color coordinate A, a second color coordinate B, a third color coordinate C, and a fourth color coordinate D results in correlation values between the target color temperature of 10000K and the lighting setting values (i.e., the first color coordinate A, the second color coordinate B, the third color coordinate C, and the fourth color coordinate D) of each light emitting element. The correlation values are a first line segment ZA, a second line segment ZB, a third line segment ZC, and a fourth line segment ZD. By summing the lengths of these four line segments, a line segment total is obtained, and then the correlation percentage of each line segment's length relative to the line segment total is calculated individually. Finally, based on the corresponding correlation percentage of each line segment's length, each light emitting element is set to provide the first colored light, the second colored light, the third colored light, and the fourth colored light with proportional emission power. The mixed light combined from the colored lights provided according to the proportional emission power achieves the desired target color temperature of 10000K and has a color rendering index (CRI) of Ra>90 and R9>50.

It should be noted that in the above-described embodiment of the light emitting system 1, each of the colored lights is provided by a single light emitting element. However, in other embodiments of the present invention, multiple first light emitting elements 101 may be used to provide the first colored light, multiple second light emitting elements 103 to provide the second colored light, multiple third light emitting elements 105 to provide the third colored light, and multiple fourth light emitting elements 107 to provide the fourth colored light. Additionally, the x and y chromaticity values of the first, second, third, and fourth color coordinates, as well as the wavelength range setting values, are merely examples of this embodiment. In other embodiments of the present invention, light emitting elements with slightly different values from those in the above examples may also be selected.

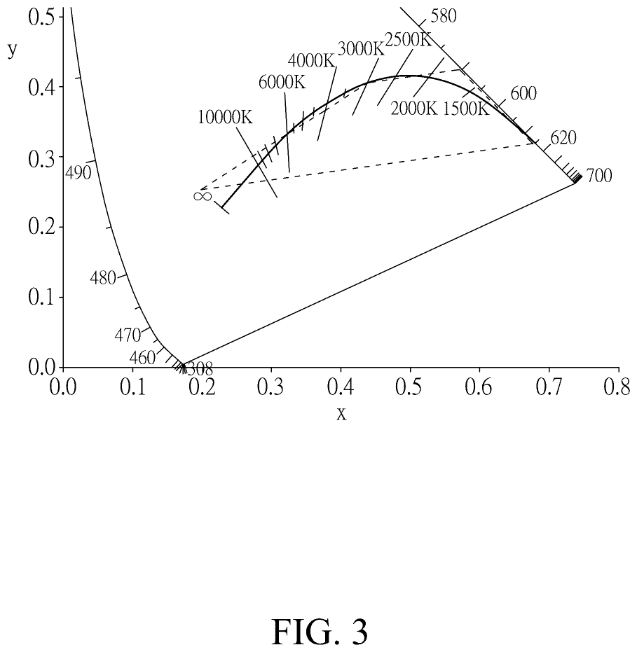

As shown in FIG. 3, by connecting the first color coordinate of the first light emitting element 101, the second color coordinate of the second light emitting element 103, the third color coordinate of the third light emitting element 105, and the fourth color coordinate of the fourth light emitting element 107 with a plurality of line segments on the 1931 CIE chromaticity diagram, a quadrilateral can be formed, indicated by the dashed lines in FIG. 3. The mixed light obtained by combining the first colored light, the second colored light, the third colored light, and the fourth colored light provided by the light emitting system 1 has a mixed light color coordinate on the 1931 CIE chromaticity diagram, which is located within this dashed quadrilateral.

It should be noted that the above-mentioned first, second, third, and fourth lighting setting values for establishing correlation values each include the chromaticity x and y values of the first, second, third, and fourth color coordinates, respectively. However, in this embodiment, the first lighting setting value, the second lighting setting value, the third lighting setting value, and the fourth lighting setting value may further include the wavelength-to-emission intensity relationships for the first colored light, the second colored light, the third colored light, and the fourth colored light, respectively.

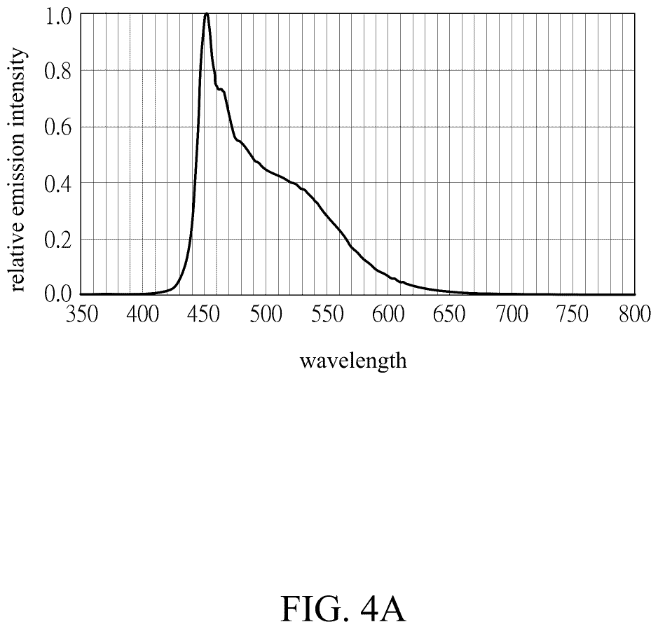

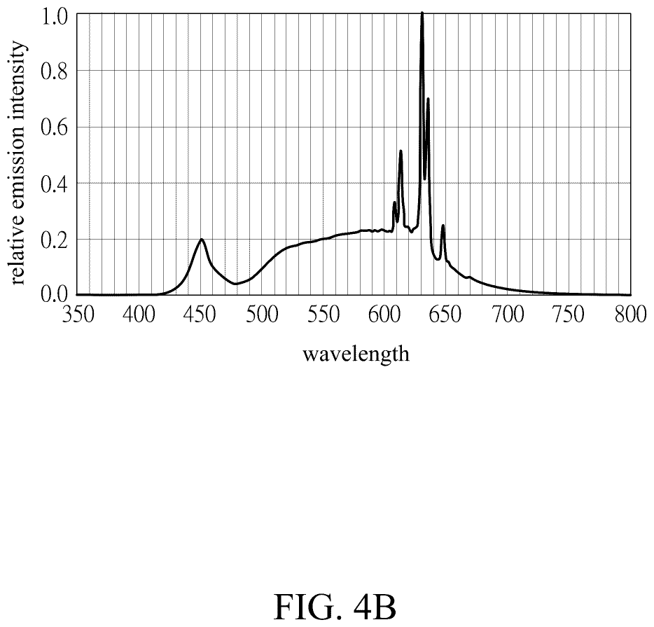

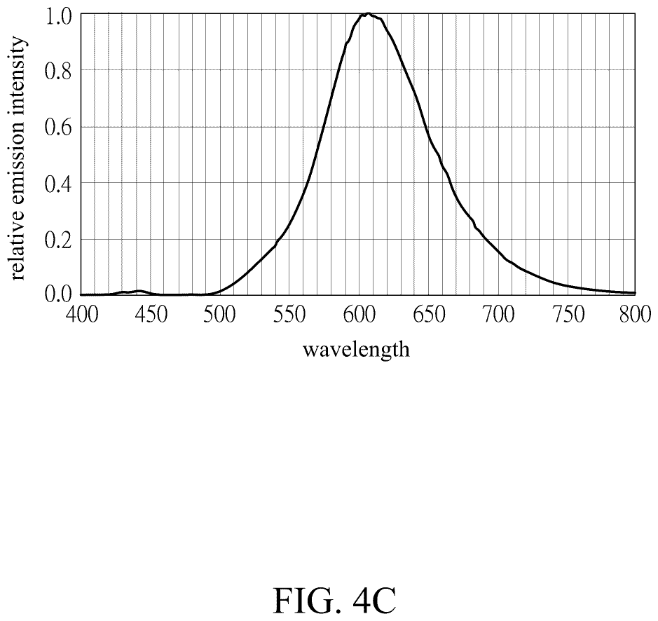

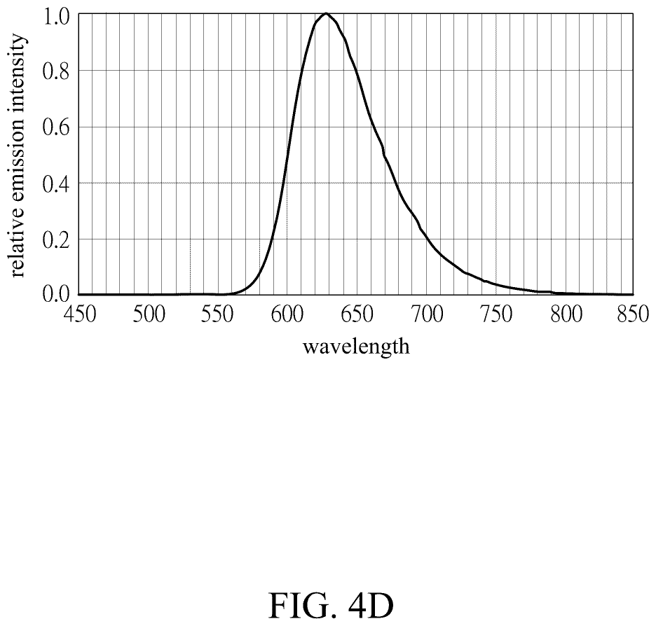

In detail, refer to FIG. 4A through FIG. 4D, which illustrate the emission intensity of the first light emitting element 101, the second light emitting element 103, the third light emitting element 105, and the fourth light emitting element 107 when providing different wavelengths. In this embodiment, the first lighting setting value further includes a first wavelength range setting value for the wavelength-to-emission intensity relationship of the first colored light; the second lighting setting value includes a second wavelength range setting value for the wavelength-to-emission intensity relationship of the second colored light; the third lighting setting value includes a third wavelength range setting value for the wavelength-to-emission intensity relationship of the third colored light; and the fourth lighting setting value includes a fourth wavelength range setting value for the wavelength-to-emission intensity relationship of the fourth colored light.

As shown in the spectrum of FIG. 4A, for the wavelength and emission intensity correlation of the first colored light, when the first wavelength range setting value is between 450 nm and 460 nm, emission intensity of the first light emitting element 101 is more than or equal to 80% of maximum emission intensity of the first light emitting element 101. When the first wavelength range setting value is between 460 nm and 470 nm, the emission intensity is between 60% and 80% of the maximum emission intensity of the first light emitting element 101. When the first wavelength range setting value is between 490 nm and 530 nm, the emission intensity is between 40% and 60% of the maximum emission intensity of the first light emitting element 101. When the first wavelength range setting value is between 540 nm and 560 nm, the emission intensity is between 20% and 40% of the maximum emission intensity of the first light emitting element 101. When the first wavelength range setting value is more than or equal to 580 nm, the emission intensity is less than or equal to 20% of the maximum emission intensity of the first light emitting element 101. As shown in the spectrum of FIG. 4B, for the wavelength and emission intensity correlation of the second colored light, when the second wavelength range setting value is between 620 nm and 640 nm, emission intensity of the second light emitting element 103 is the maximum emission intensity of the second light emitting element 103. When the second wavelength range setting value is between 400 nm and 500 nm, the emission intensity of the second light emitting element 103 is less than or equal to 30% of the maximum emission intensity of the second light emitting element 103. When the second wavelength range setting value is between 500 nm and 600 nm, the emission intensity of the second light emitting element 103 is between 5% and 30% of the maximum emission intensity of the second light emitting element 103. When the second wavelength range setting value is between 600 nm and 620 nm, the emission intensity of the second light emitting element 103 is between 40% and 100% of the maximum emission intensity of the second light emitting element 103. When the second wavelength range setting value is between 640 nm and 650 nm, the emission intensity of the second light emitting element 103 is between 20% and 30% of the maximum of the second light emitting element 103. As shown in the spectrum of FIG. 4C, for the wavelength and emission intensity correlation of the third colored light, when the third wavelength range setting value is between 590 nm and 630 nm, emission intensity of the third light emitting element 105 is more than or equal to 80% of the maximum emission intensity of the third light emitting element 105. When the third wavelength range setting value is between 410 nm and 470 nm, the emission intensity of the third light emitting element 105 is between 1% and 5% of the maximum emission intensity of the third light emitting element 105. As shown in the spectrum of FIG. 4D, for the wavelength and emission intensity correlation of the fourth colored light, when the fourth wavelength range setting value is between 620 nm and 650 nm, emission intensity of the fourth light emitting element 107 is more than or equal to 80% of the maximum emission intensity of the fourth light emitting element 107. When the fourth wavelength range setting value is less than or equal to 580 nm, the emission intensity of the fourth light emitting element 107 is less than or equal to 20% of the maximum emission intensity of the fourth light emitting element 107. When the fourth wavelength range setting value is between 590 nm and 600 nm, the emission intensity of the fourth light emitting element 107 is between 20% and 60% of the maximum emission intensity of the fourth light emitting element 107. When the fourth wavelength range setting value is between 600 nm and 610 nm, the emission intensity of the fourth light emitting element 107 is between 40% and 80% of the maximum of the fourth light emitting element 107. When the fourth wavelength range setting value is between 660 nm and 670 nm, the emission intensity is between 40% and 80% of the maximum emission intensity of the fourth light emitting element 107. When the fourth wavelength range setting value is between 680 nm and 700 nm, the emission intensity of the fourth light emitting element 107 is between 20% and 40% of the maximum emission intensity of the fourth light emitting element 107. When the fourth wavelength range setting value is between 710 nm and 810 nm, the emission intensity of the fourth light emitting element 107 is less than or equal to 20% of the maximum emission intensity of the fourth light emitting element 107.

Table 1 below lists the emission power provided by the first light emitting element 101 through the fourth light emitting element 107 for various target color temperatures. As shown in the table, the light emitting system 1 of this embodiment can provide continuous dimming from 1000K to 12000K. In practical applications, each 100K color temperature increment represents a distinct stage. A target color temperature of 2700K can provide light similar to sunrise or dusk, 3500K can provide light similar to early morning, 4000K can provide light similar to moonlight, 5000K can provide light similar to overcast conditions, and 6000K can provide light similar to a clear noon.

TABLE 1

| | first light | second light | third light | fourth light |
|---|---|---|---|---|
| target color | emitting | emitting | emitting | emitting |
| temperature | element | element | element | element |
| 1000 K | 0% | 14% | 27% | 59% |
| 1500 K | 0% | 14% | 51% | 35% |
| 1800 K | 0% | 36% | 52% | 12% |
| 2200 K | 0% | 55% | 45% | 0% |
| 2700 K | 0% | 82% | 18% | 0% |
| 3000 K | 0% | 100% | 0% | 0% |
| 3500 K | 15% | 86% | 0% | 0% |
| 4000 K | 28% | 72% | 0% | 0% |
| 5000 K | 36% | 64% | 0% | 0% |
| 6500 K | 54% | 46% | 0% | 0% |
| 8000 K | 56% | 25% | 0% | 19% |
| 12000 K | 61% | 28% | 0% | 11% |

From the above table, it can be seen that when the light emitting system 1 of this embodiment uses the first light emitting element 101, the second light emitting element 103, the third light emitting element 105, and the fourth light emitting element 107 to provide mixed light that matches the target color temperature, the following conditions apply: when the emission power of the first light emitting element 101 is significantly greater than the emission powers of the second light emitting element 103, the third light emitting element 105, and the fourth light emitting element 107, the upper limit of the target color temperature is 12000K; when the emission power of the second light emitting element 103 is significantly greater than the emission powers of the first light emitting element 101, the third light emitting element 105, and the fourth light emitting element 107, the target color temperature is 3000K; when the emission power of the third light emitting element 105 is significantly greater than the emission powers of the first light emitting element 101, the second light emitting element 103, and the fourth light emitting element 107, the lower limit of the target color temperature is 1800K; and when the emission power of the fourth light emitting element 107 is significantly greater than the emission powers of the first light emitting element 101, the second light emitting element 103, and the third light emitting element 105, the lower limit of the target color temperature is 1000K.

When the light emitting system is applied in practical lighting scenarios, a color temperature range of 2200K to 6500K is commonly used in living environments. In this embodiment, the light emitting system 1 can provide the mixed light with the target color temperature that meets most usage scenarios by using only the first light emitting element 101 and the second light emitting element 103, or by using only the first light emitting element 101 and the fourth light emitting element 107.

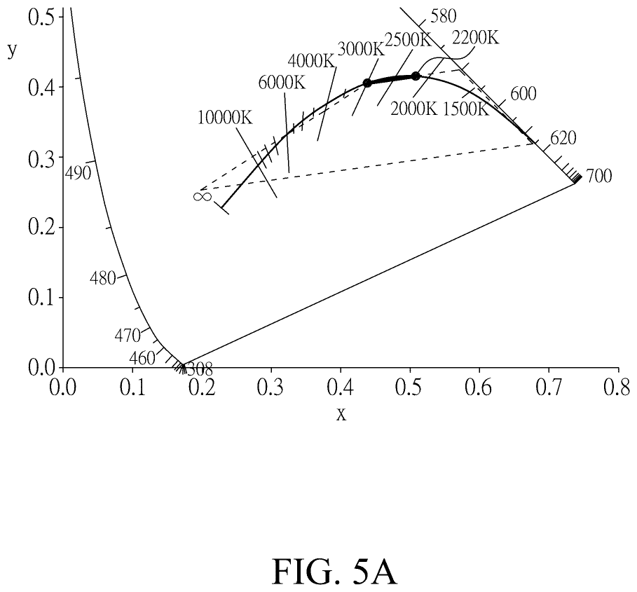

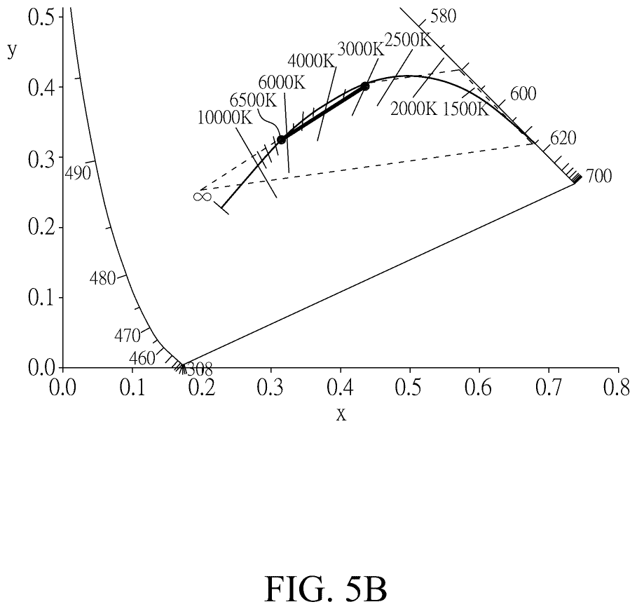

Specifically, as shown in the chromaticity diagram of FIG. 5A, when only the first light emitting element 101 and the second light emitting element 103 of the light emitting system 1 are used to provide light, with the emission powers of the third light emitting element 105 and the fourth light emitting element 107 being set to zero, the target color temperature range that light emitting system 1 can provide is from 3000K to 6500K. After selecting a target color temperature within this range, adjustments can be made to set the first light emitting element 101 and the second light emitting element 103 to appropriate emission powers (as exemplified in the table above) to provide a mixed light that meets the target color temperature. It should be noted that when the target color temperature is 3000K, only the second light emitting element 103 provides light. Therefore, when the emission power of the first light emitting element 101 is greater than that of the second light emitting element 103, the upper limit of the target color temperature is 6500K. Conversely, when the emission power of the first light emitting element 101 is less than that of the second light emitting element 103, the lower limit of the color temperature is 3000K.

Additionally, when the light emitting system 1 of this embodiment uses only the second light emitting element 103 and the third light emitting element 105 to provide light, as shown in the chromaticity diagram of FIG. 5B, with the emission powers of the first light emitting element 101 and the fourth light emitting element 107 being set to zero, the target color temperature range that light emitting system 1 can provide is from 2200K to 3000K. After selecting a target color temperature within this range, adjustments can be made to set the first light emitting element 101 and the fourth light emitting element 107 to appropriate emission powers (as exemplified in the table above) to provide a mixed light that meets the target color temperature. Similarly, it should be noted that when the target color temperature is 3000K, only the second light emitting element 103 provides light. Therefore, when the emission power of the second light emitting element 103 is greater than that of the third light emitting element 105, the upper limit of the target color temperature is 3000K. Conversely, when the emission power of the second light emitting element 103 is less than that of the third light emitting element 105, the lower limit of the color temperature is 2200K.

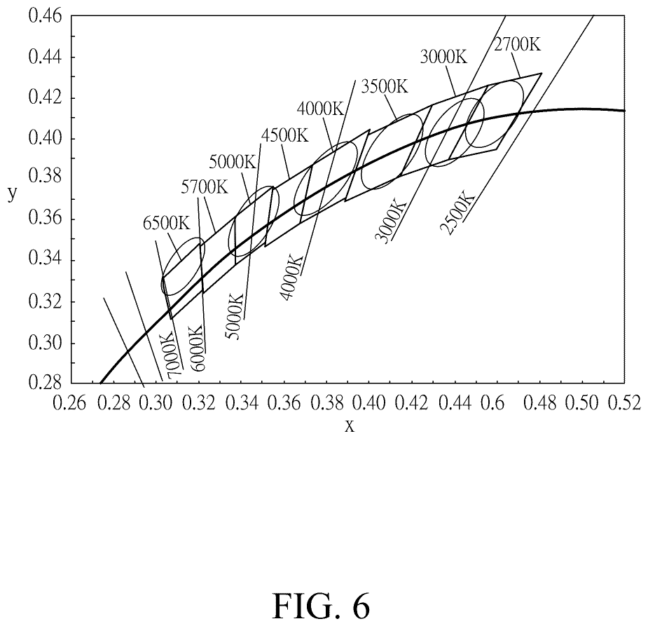

The distance between the color temperature of the light and the blackbody locus (also known as the Planckian locus) indicates the perceptual difference of the object to the human eye. The chromaticity deviation value (Duv) of the mixed light in the embodiment of the present invention is within the target 7-step MacAdam Ellipse corresponding to the target color temperature. As shown in the 1931 CIE chromaticity diagram of FIG. 6, when the target color temperatures are set to 2700K, 3000K, 3500K, 4000K, 5000K, or 6500K, the corresponding 7-step MacAdam ellipses (7-step MAE) for each target color temperature are as illustrated. In other words, the color coordinates of the mixed light in this embodiment fall within the seven MacAdam ellipses of the blackbody locus. Additionally, the color tolerance of the mixed light in this embodiment is also depicted in FIG. 6. The color tolerance range of the mixed light is shown by multiple quadrilaterals in the figure, with corresponding color temperatures of 2700K, 3000K, 3500K, 4000K, 4500K, 5000K, 5700K, and 6500K, which are related to the nominal correlated color temperatures (Nominal CCT) as currently standardized in the United States. Table 2 lists the color tolerance coordinates for 2700K, 3500K, 4000K, 5000K, and 6500K. From the above and the figures, it can be seen that the mixed light provided by this embodiment does not exhibit noticeable color differences to the naked eye for general users.

TABLE 2

| | target color temperature | | | | | | | | | |
|---|---|---|---|---|---|---|---|---|---|---|
| | 2700 K | | 3500 K | | 4000 K | | 5000 K | | 6500 K | |
| coordinate position | x | y | x | y | x | y | x | y | x | y |
| upper right | 0.4813 | 0.4319 | 0.4299 | 0.4165 | 0.4006 | 0.4044 | 0.3551 | 0.3760 | 0.3205 | 0.3481 |
| upper left | 0.4562 | 0.4260 | 0.3996 | 0.4015 | 0.3736 | 0.3874 | 0.3376 | 0.3616 | 0.3028 | 0.3304 |
| lower left | 0.4373 | 0.3893 | 0.3889 | 0.369 | 0.3670 | 0.3578 | 0.3366 | 0.3369 | 0.3068 | 0.3113 |
| lower right | 0.4593 | 0.3944 | 0.4147 | 0.3814 | 0.3898 | 0.3716 | 0.3515 | 0.3487 | 0.3221 | 0.3261 |

In summary, the present invention requires only a single light emitting system to select and to be adjusted the target color temperature across the full range of color temperatures. The adjusted mixed light not only meets the target color temperature but also has a color rendering index (CRI) greater than 90 (Ra>90), with excellent color rendering capability for high-chroma reds (R9>50). This enables extremely accurate color reproduction of objects under the illumination of the light emitting system of the present invention. Moreover, the chromaticity deviation value (Duv) and color tolerance of the mixed light provided by the light emitting system of the present invention are very small compared to the blackbody locus, falling within a range that is imperceptible to the naked eye. Therefore, lighting with the various color temperature mixed lights provided by the present invention will render the most accurate colors of the illuminated objects.

The above embodiments are used only to illustrate the implementations of the present invention and to explain the technical features of the present invention, and are not used to limit the scope of the present invention. Any modifications or equivalent arrangements that can be easily accomplished by people skilled in the art are considered to fall within the scope of the present invention, and the scope of the present invention should be limited by the claims of the patent application.

What is claimed is:

1. An adjustment method for a light emitting system, the light emitting system comprising a plurality of light emitting elements, the adjustment method comprising:
setting a target color temperature between 1000K and 12000K;
establishing a correlation value between the target color temperature and a lighting setting value of each of the light emitting elements;
calculating a total of the correlation values;
individually calculating a correlation percentage of each of the correlation values relative to the total; and
setting emission power of each of the light emitting elements according to the corresponding correlation percentage to collectively provide mixed light.

2. The adjustment method of claim 1, wherein each of the lighting setting values includes at least one of a color coordinate and a wavelength range setting value.

3. The adjustment method of claim 2, wherein the light emitting elements are selected from the group consisting of a first light emitting element, a second light emitting element, a third light emitting element, a fourth light emitting element, and combinations thereof, the lighting setting value of the first light emitting element includes a first color coordinate, the first color coordinate is a chromaticity x value of 0.16-0.22 and a chromaticity y value of 0.23-0.3 on the 1931 CIE chromaticity diagram, the lighting setting value of the second light emitting element includes a second color coordinate, the second color coordinate is a chromaticity x value of 0.37-0.47 and a chromaticity y value of 0.36-0.43 on the 1931 CIE chromaticity diagram, the lighting setting value of the third light emitting element includes a third color coordinate, the third color coordinate is a chromaticity x value of 0.53-0.6 and a chromaticity y value of 0.4-0.45 on the 1931 CIE chromaticity diagram, the lighting setting value of the fourth light emitting element includes a fourth color coordinate, and the fourth color coordinate is a chromaticity x value of 0.645-0.68 and a chromaticity y value of 0.32-0.335 on the 1931 CIE chromaticity diagram.

4. The adjustment method of claim 3, wherein on the 1931 CIE chromaticity diagram, the first color coordinate, the second color coordinate, the third color coordinate, and the fourth color coordinate are connected by a plurality of line segments to form a quadrilateral, and the mixed light has a mixed light color coordinate on the 1931 CIE chromaticity diagram, and the mixed light color coordinate is located within the quadrilateral.

5. The adjustment method of claim 4, wherein the lighting setting value of the first light emitting element includes a first wavelength range setting value, when the first wavelength range setting value is between 450 nm and 460 nm, emission intensity of the first light emitting element is more than or equal to 80% of maximum emission intensity of the first light emitting element, the lighting setting value of the second light emitting element includes a second wavelength range setting value, when the second wavelength range setting value is between 620 nm and 640 nm, emission intensity of the second light emitting element is at maximum emission intensity of the second light emitting element, the lighting setting value of the third light emitting element includes a third wavelength range setting value, when the third wavelength range setting value is between 590 nm and 630 nm, emission intensity of the third light emitting element is more than or equal to 80% of maximum emission intensity of the third light emitting element, the lighting setting value of the fourth light emitting element includes a fourth wavelength range setting value, and when the fourth wavelength range setting value is between 620 nm and 650 nm, emission intensity of the fourth light emitting element is more than or equal to 80% of maximum emission intensity of the fourth light emitting element.

6. The adjustment method of claim 5, wherein
when the first wavelength range setting value is between 460 nm and 470 nm, the emission intensity of the first light emitting element is between 60% and 80% of the maximum emission intensity of the first light emitting element, when the first wavelength range setting value is between 490 nm and 530 nm, the emission intensity of the first light emitting element is between 40% and 60% of the maximum emission intensity of the first light emitting element, when the first wavelength range setting value is between 540 nm and 560 nm, the emission intensity of the first light emitting element is between 20% and 40% of the maximum emission intensity of the first light emitting element, when the first wavelength range setting value is more than or equal to 580 nm, the emission intensity of the first light emitting element is less than or equal to 20% of the maximum emission intensity of the first light emitting element,
when the second wavelength range setting value is between 400 nm and 500 nm, the emission intensity of the second light emitting element is less than or equal to 30% of the maximum emission intensity of the second light emitting element, when the second wavelength range setting value is between 500 nm and 600 nm, the emission intensity of the second light emitting element is between 5% and 30% of the maximum emission intensity of the second light emitting element, when the second wavelength range setting value is between 600 nm and 620 nm, the emission intensity of the second light emitting element is between 40% and the maximum emission intensity of the second light emitting element, when the second wavelength range setting value is between 640 nm and 650 nm, the emission intensity of the second light emitting element is between 20% and 30% of the maximum emission intensity of the second light emitting element,
when the third wavelength range setting value is between 410 nm and 470 nm, the emission intensity of the third light emitting element is between 1% and 5% of the maximum emission intensity of the third light emitting element,
when the fourth wavelength range setting value is below 580 nm, the emission intensity of the fourth light emitting element is less than or equal to 20% of the maximum emission intensity of the fourth light emitting element, when the fourth wavelength range setting value is between 590 nm and 600 nm, the emission intensity of the fourth light emitting element is between 20% and 60% of the maximum emission intensity of the fourth light emitting element, when the fourth wavelength range setting value is between 600 nm and 610 nm, the emission intensity of the fourth light emitting element is between 40% and 80% of the maximum emission intensity of the fourth light emitting element, when the fourth wavelength range setting value is between 660 nm and 670 nm, the emission intensity of the fourth light emitting element is between 40% and 80% of the maximum emission intensity of the fourth light emitting element, when the fourth wavelength range setting value is between 680 nm and 700 nm, the emission intensity of the fourth light emitting element is between 20% and 40% of the maximum emission intensity of the fourth light emitting element, when the fourth wavelength range setting value is between 710 nm and 810 nm, the emission intensity of the fourth light emitting element is less than or equal to 20% of the maximum emission intensity of the fourth light emitting element.

7. The adjustment method of claim 6, wherein a chromaticity deviation value (Duv) of the mixed light is that the mixed light color coordinate is located within a target 7-step MacAdam Ellipse corresponding to the target color temperature.

8. The adjustment method of claim 7, wherein in the step of establishing a correlation value between the target color temperature and a lighting setting value of each of the light emitting elements, the target color temperature is plotted on the 1931 CIE chromaticity diagram, and lines are drawn connecting the target color temperature on the 1931 CIE chromaticity diagram with the first color coordinate, the second color coordinate, the third color coordinate, and the fourth color coordinate, resulting in a first line segment, a second line segment, a third line segment, and a fourth line segment, each of the correlation values of each of the light emitting elements is positively correlated with a length of the corresponding line segments.

9. The adjustment method of claim 8, wherein each of the correlation percentages is positively correlated with the corresponding emission power.

10. The adjustment method of claim 9, wherein the color rendering index (CRI) of the mixed light has Ra>90 and R9>50.

11. The adjustment method of claim 10, wherein when the emission power of the third light emitting element and the emission power of the fourth light emitting element are both set to 0, the target color temperature ranges between 3000K and 6500K.

12. The adjustment method of claim 11, wherein when the emission power of the first light emitting element and the emission power of the fourth light emitting element are both set to 0, the target color temperature ranges between 2200K and 3000K.

13. A light emitting system, comprising:
a first light emitting element, providing a first colored light, represented by a first color coordinate on the 1931 CIE chromaticity diagram, with a chromaticity x value of 0.16-0.22 and a chromaticity y value of 0.23-0.3, and when a wavelength of the first colored light is between 450 nm and 460 nm, emission intensity of the first light emitting element is more than or equal to 80% of maximum emission intensity of the first light emitting element;
a second light emitting element, providing a second colored light, represented by a second color coordinate on the 1931 CIE chromaticity diagram, with a chromaticity x value of 0.37-0.47 and a chromaticity y value of 0.36-0.43, and when a wavelength of the second colored light is between 620 nm and 640 nm, emission intensity of the second light emitting element is at maximum emission intensity of the second light emitting element;
a third light emitting element, providing a third colored light, represented by a third color coordinate on the 1931 CIE chromaticity diagram, with a chromaticity x value of 0.53-0.6 and a chromaticity y value of 0.4-0.45, and when a wavelength of the third colored light is between 590 nm and 630 nm, emission intensity of the third light emitting element is more than or equal to 80% of maximum emission intensity of the third light emitting element;
a fourth light emitting element, providing a fourth colored light, represented by a fourth color coordinate on the 1931 CIE chromaticity diagram, with a chromaticity x value of 0.645-0.68 and a chromaticity y value of 0.32-0.335, and when a wavelength of the fourth colored light is between 620 nm and 650 nm, emission intensity of the fourth light emitting element is more than or equal to 80% of maximum emission intensity of the fourth light emitting element; and
a control circuit, based on a target color temperature and the chromaticity x and y values, providing a first emission power ratio signal to the first light emitting element to provide the first colored light, providing a second emission power ratio signal to the second light emitting element to provide the second colored light, providing a third emission power ratio signal to the third light emitting element to provide the third colored light, and providing a fourth emission power ratio signal to the fourth light emitting element to provide the fourth colored light, wherein the target color temperature ranges between 1000K and 12000K.

14. The light emitting system of claim 13, wherein on the 1931 CIE chromaticity diagram, the first color coordinate, the second color coordinate, the third color coordinate, and the fourth color coordinate are connected by a plurality of line segments to form a quadrilateral, and the first colored light, the second colored light, the third colored light, and the fourth colored light are combined to obtain mixed light, the mixed light has a mixed light color coordinate on the 1931 CIE chromaticity diagram, and the mixed light color coordinate is located within the quadrilateral.

15. The light emitting system of claim 14, wherein a chromaticity deviation value (Duv) of the mixed light is that the mixed light color coordinate is located within a target 7-step MacAdam Ellipse corresponding to the target color temperature.

16. The light emitting system of claim 15, wherein when the wavelength of the first colored light is between 460 nm and 470 nm, the emission intensity of the first light emitting element is between 60% and 80% of the maximum emission intensity of the first light emitting element, when the wavelength of the first colored light is between 490 nm and 530 nm, the emission intensity of the first light emitting element is between 40% and 60% of the maximum emission intensity of the first light emitting element, when the wavelength of the first colored light is between 540 nm and 560 nm, the emission intensity of the first light emitting element is between 20% and 40% of the maximum emission intensity of the first light emitting element, when the wavelength of the first colored light is more than or equal to 580 nm, the emission intensity of the first light emitting element is less than or equal to 20% of the maximum emission intensity of the first light emitting element, when the wavelength of the second colored light is between 400 nm and 500 nm, the emission intensity of the second light emitting element is less than or equal to 30% of the maximum emission intensity of the second light emitting element, when the wavelength of the second colored light is between 500 nm and 600 nm, the emission intensity of the second light emitting element is between 5% and 30% of the maximum emission intensity of the second light emitting element, when the wavelength of the second colored light is between 600 nm and 620 nm, the emission intensity of the second light emitting element is between 40% and the maximum emission intensity of the second light emitting element, when the wavelength of the second colored light is between 640 nm and 650 nm, the emission intensity of the second light emitting element is between 20% and 30% of the maximum emission intensity of the second light emitting element, when the wavelength of the third colored light is between 410 nm and 470 nm, the emission intensity of the third light emitting element is between 1% and 5% of the maximum emission intensity of the third light emitting element, when the wavelength of the fourth colored light is below 580 nm, the emission intensity of the fourth light emitting element is less than or equal to 20% of the maximum emission intensity of the fourth light emitting element, when the wavelength of the fourth colored light is between 590 nm and 600 nm, the emission intensity of the fourth light emitting element is between 20% and 60% of the maximum emission intensity of the fourth light emitting element, when the wavelength of the fourth colored light is between 600 nm and 610 nm, the emission intensity of the fourth light emitting element is between 40% and 80% of the maximum emission intensity of the fourth light emitting element, when the wavelength of the fourth colored light is between 660 nm and 670 nm, the emission intensity of the fourth light emitting element is between 40% and 80% of the maximum emission intensity of the fourth light emitting element, when the wavelength of the fourth colored light is between 680 nm and 700 nm, the emission intensity of the fourth light emitting element is between 20% and 40% of the maximum emission intensity of the fourth light emitting element, and when the wavelength of the fourth colored light is between 710 nm and 810 nm, the emission intensity of the fourth light emitting element is less than or equal to 20% of the maximum emission intensity of the fourth light emitting element.

17. The light emitting system of claim 16, wherein the color rendering index (CRI) of the mixed light has Ra>90 and R9>50.

18. The light emitting system of claim 17, wherein when the emission power of the third light emitting element and the emission power of the fourth light emitting element are both set to 0, the target color temperature ranges between 3000K and 6500K.

19. The light emitting system of claim 18, wherein when the emission power of the first light emitting element and the emission power of the fourth light emitting element are both set to 0, the target color temperature ranges between 2200K and 3000K.
